(19) United States
(12) Patent Application Publication
(10) Pub. No.: US 2012/0092541 A1
(43) Pub. Date: Apr. 19, 2012

(54) Method and apparatus for ambient light measurement system

(75) Inventors: Eero Tuulos, Vuorentausta (FI); Eero Salmelin, Tampere (FI); Juha Alakarhu, Helsinki (FI); Saku Hieta, Helsinki (FI)

(73) Assignee: Nokia Corporation

(21) Appl. No.: 12/925,356

(22) Filed: Oct. 19, 2010

(51) Int. Cl. H04N 5/222

(52) U.S. Cl. 348/333.01; 348/E05.022

(57) ABSTRACT

In accordance with an example embodiment of the present invention, an apparatus is disclosed. The apparatus includes a display and a combined camera and ambient light measurement arrangement having photosensitive elements. The arrangement is configured to operate in a first power mode and a second different power mode. The arrangement is configured to use the photosensitive elements to measure a color signal of light incident on the display when the arrangement is in the first power mode. The arrangement is configured to use the photosensitive elements to capture an image when the arrangement is in the second power mode.

### TECHNICAL FIELD

The invention relates to an ambient light measurement system and, more particularly, to an ambient light measurement system for an electronic device.

### BACKGROUND

Display brightness in cellular phones is usually automatically adjusted based on the ambient light conditions. For the measurement of the ambient light level, a discrete ambient light sensor (ALS) is traditionally used. The ambient light sensor (ALS) generally monitors the illumination level of the environment where the mobile phone is being used. The keypad/display backlight brightness may then be adjusted based on this measurement to suit ambient lighting conditions.

As electronic devices continue to become more sophisticated, these devices provide an increasing amount of functionality by including such applications as, for example, a mobile phone, digital camera, video camera, navigation system, gaming capabilities, and internet browser applications. With this increasing amount of functionality, device features such as the keypad/display backlight brightness may be evaluated for power consumption purposes.

Accordingly, as consumers demand increased functionality from electronic devices, there is a need to provide improved devices having increased capabilities, such as improved power saving, while maintaining robust and reliable product configurations.

### SUMMARY

Various aspects of examples of the invention are set out in the claims.

According to a first aspect of the present invention, an apparatus is disclosed. The apparatus includes a display and a combined camera and ambient light measurement arrangement having photosensitive elements. The arrangement is configured to operate in a first power mode and a second different power mode. The arrangement is configured to use the photosensitive elements to measure a color signal of light incident on the display when the arrangement is in the first power mode. The arrangement is configured to use the photosensitive elements to capture an image when the arrangement is in the second power mode.

According to a second aspect of the present invention, an apparatus is disclosed. The apparatus includes a camera, at least one processor, and at least one memory. The camera includes photosensitive elements. The at least one processor is connected to the camera. The at least one memory includes computer program code. The at least one memory and the computer program code are configured to, with the at least one processor, cause the apparatus to perform at least the following. Sense a first ambient light level with the photosensitive elements, wherein the first ambient light level corresponds with a portion of a field of view of the camera. Capture an image with the photosensitive elements in the field of view of the camera. Adjust a brightness of a display of the apparatus in response to the sensed first ambient light level.

According to a third aspect of the present invention, a computer program product is disclosed. The computer program product includes a computer-readable medium bearing computer program code embodied therein for use with a computer. The computer program code includes code for measuring a color signal of light incident on a display of an apparatus. The measuring is performed, at least partially, with photosensitive elements of the apparatus. The computer program code includes code for capturing an image with the photosensitive elements. The computer program code includes code for adjusting an illumination brightness of the display based on the measured color signal of the light incident on the display of the apparatus.

### BRIEF DESCRIPTION OF THE DRAWINGS

For a more complete understanding of example embodiments of the present invention, reference is now made to the following descriptions taken in connection with the accompanying drawings in which:

FIG. 1 is a front view of an electronic device incorporating features of the invention;

FIG. 2 is a rear view of the electronic device shown in FIG. 1;

FIG. 3 is a representation illustrating the addressing of different color channel pixels used in the device shown in FIG. 1;

FIG. 4 is a representation illustrating multiple regions of interest of a sensor array used in the device shown in FIG. 1;

FIG. 5 is a representation illustrating an arrangement of light sensing elements used in the device shown in FIG. 1;

FIG. 6 is a representation illustrating a location of a light sensing area used in the device shown in FIG. 1;

FIG. 7 is a representation illustrating other locations of the light sensing area used in the device shown in FIG. 1;

FIG. 8 is a representation illustrating reading out a skipped pixel of the pixel array, used in the device shown in FIG. 1;

FIG. 9 is a representation illustrating reading out a skipped pixel group of the pixel array, used in the device shown in FIG. 1;

FIG. 10 is an exemplary method of the device shown in FIG. 1; and

FIG. 11 is a schematic drawing illustrating components of the device shown in FIG. 1.

### DETAILED DESCRIPTION OF THE DRAWINGS

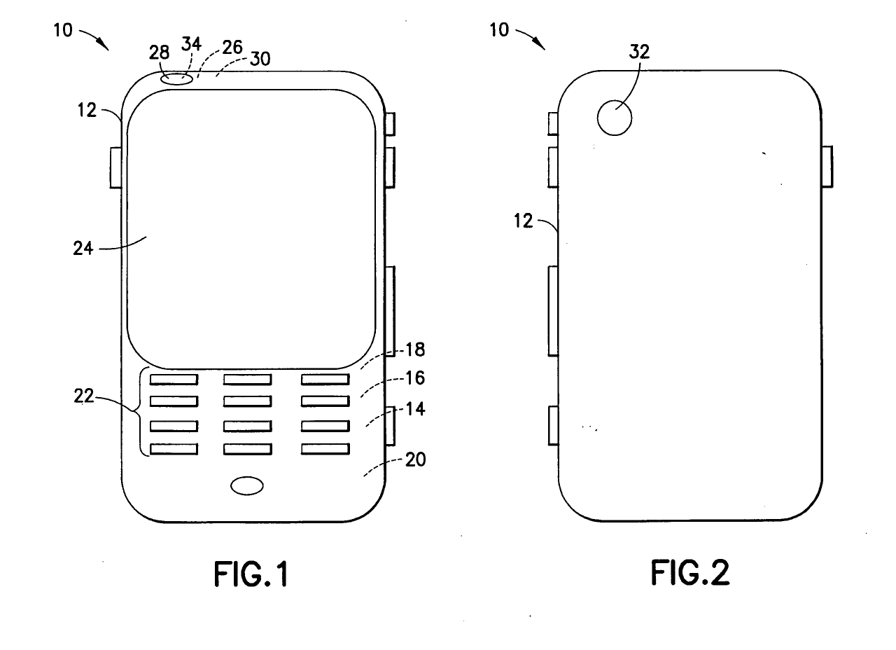

An example embodiment of the present invention and its potential advantages are understood by referring to FIGS. 1 through 11 of the drawings.

Referring to FIG. 1, there is shown a front view of an electronic device 10 incorporating features of the invention. Although the invention will be described with reference to the exemplary embodiments shown in the drawings, it should be understood that the invention can be embodied in many alternate forms of embodiments. In addition, any suitable size, shape or type of elements or materials could be used.

According to one example of the invention, the device 10 is a multi-function portable electronic device. However, in alternate embodiments, features of the various embodiments of the invention could be used in any suitable type of portable electronic device such as a mobile phone, a gaming device, a music player, a notebook computer, or a personal digital assistant, for example. In addition, as is known in the art, the device 10 can include multiple features or applications such as a camera, a music player, a game player, or an Internet browser, for example. The device 10 generally comprises a housing 12, a transmitter 14, a receiver 16, an antenna (connected to the transmitter 14 and the receiver 16), electronic circuitry 20, such as a controller (which could include a processor, for example) and a memory for example, within the housing 12, a user input region 22 and a display 24. The display 24 could also form a user input section, such as a touch screen. It should be noted that in alternate embodiments, the device 10 can have any suitable type of features as known in the art.

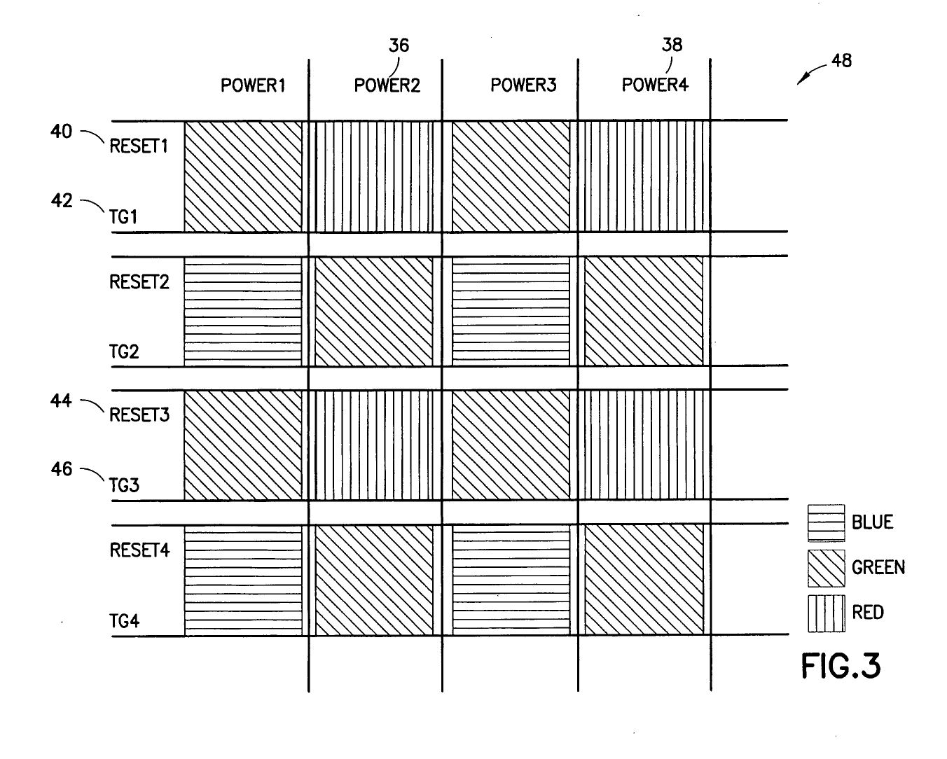

The electronic device 10 further comprises a combined camera and ambient light measurement arrangement (or system) 26. The arrangement is configured to monitor the illumination level of the environment where the device 10 is being used such that keypad 22 and/or display 24 backlight brightness can be adjusted based on the measured illumination level. The combined camera and ambient light measurement arrangement 26 comprises a forward facing camera 28 and a measurement readout circuit 30. According to some exemplary embodiments of the invention, the forward facing camera 28 may be a secondary camera of the device 10, wherein the device 10 comprises a rearward facing primary camera 32 (see FIG. 2) configured for capturing images and video for local storage, and the forward facing secondary camera 28 configured to be used for video calls, for example. However, it should be noted that any suitable number of cameras may be provided. For example, according to some embodiments of the invention, the device 10 may comprise only the single camera 28. According to some other embodiments of the invention, the device may comprise more than two cameras.

The arrangement 26 provides for adding ambient light sensing functionality to the camera 28. For example the arrangement 26 is configured to allow the camera 28 to operate in either a camera mode or in a measurement mode.

The camera 28, which may be substantially aligned with a viewing angle of the display 24, includes photosensitive elements 34. When the camera 28 is operating in a normal camera mode (such as a mode configured for image capture), the camera surface may be divided to a substantially large number of very small photosensitive pixels in order to be able to construct an image of the scene the camera is capturing. When in the normal camera mode, the arrangement 26 operates in a normal (or full) power mode to utilize a camera readout circuit which allows for image processing and a data rate suitable for image capture/processing.

When the camera 28 is operating in a measurement mode (such as a mode configured for ambient light measurement), the camera 28 is configured to act as a sensor and combine the pixels together and measure photocurrent. This provides for one signal representing light level, wherein also color information is gathered from the sensor (or camera) 28 by combining one color channel pixels together and measuring the required current that flows through the array when light hits the pixels. When in the measurement mode, the arrangement 26 operates in a low power mode to utilize the measurement readout circuit 30 which allows for a low data rate (such as a data rate substantially lower than the date rate used for image capture while in the camera mode) suitable for ambient light sensing.

When in the measurement mode, the arrangement 26 provides for combining the pixels together, measuring photocurrent, and additionally measuring the color signal and coarse spatial information, while still maintaining low power consumption and low data rate. According to some embodiments of the invention, this can be provided by adding pixel power line control that allows power line to each column of pixels to be addressable, rowwise addressing by using Reset (and transfer gate [TG]) lines is generally part of readout circuitry in standard complimentary metal oxide semiconductor (CMOS) sensors.

Referring now also to FIG. 3, the addressing (by the arrangement 26) of different color channels (or color channel pixels) to measure individual color channel signals is illustrated. For example, according to some embodiments of the invention, the measurement of average Red signal (see areas with vertical line shading) from all over the array 48 is achieved by activating Power2 (see 36), Power4 (see 38), and so forth, and Reset1 (see 40), TG1 (see 42), Reset3 (see 44), TG3 (see 46), and so forth, signals and then measuring the current that flows from power lines to substrate (se FIG. 3). Additionally, the same could be used for each of the color channels.

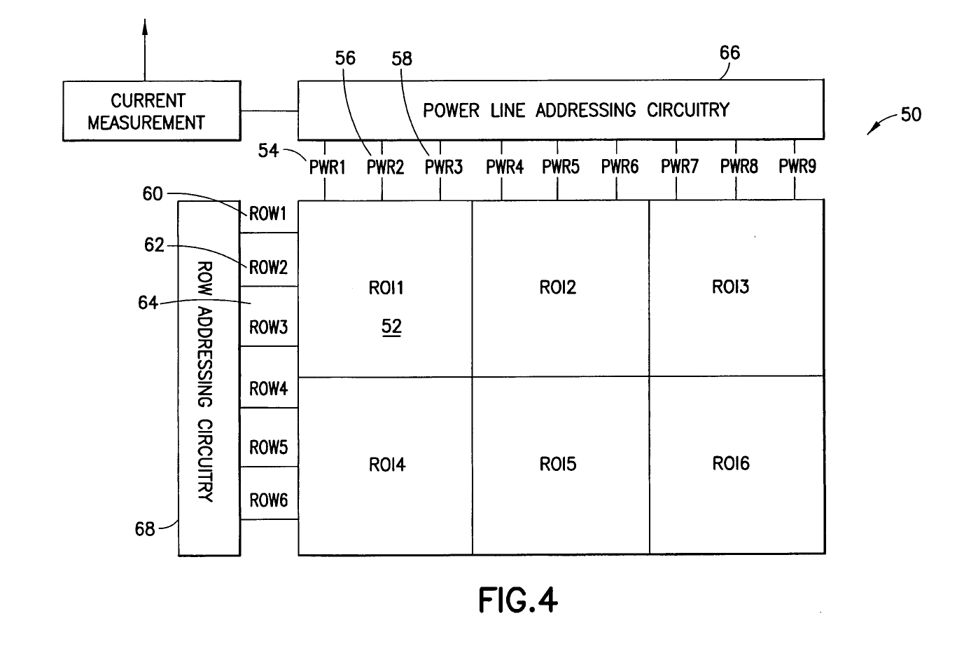

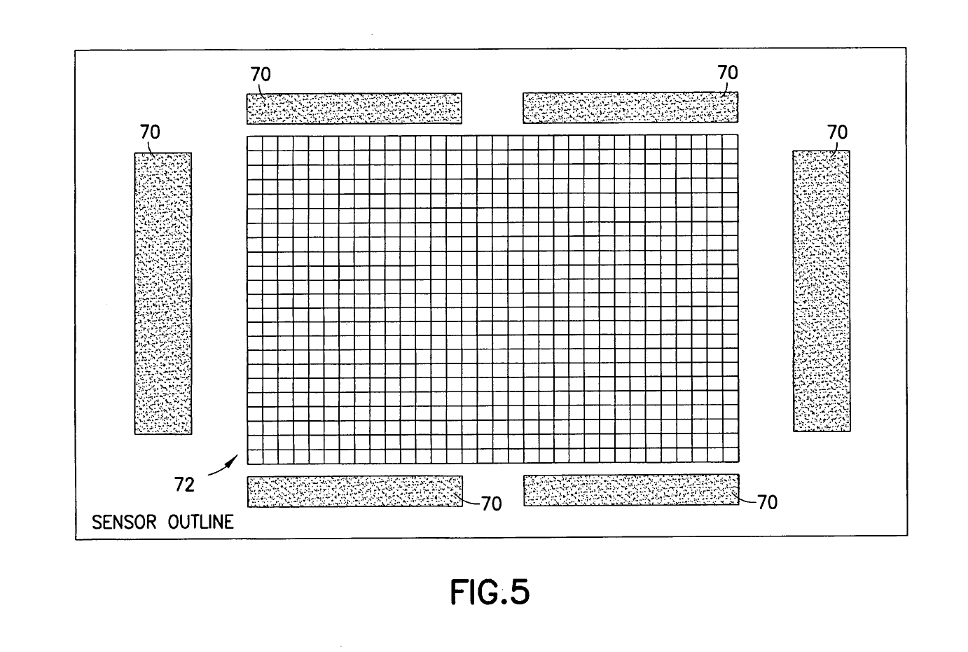

Referring now also to FIG. 4, the principle of dividing the sensor array 50 (by the arrangement 26) to multiple regions of interest (or addressing of different regions of interest [ROI]) is illustrated. For example, according to some embodiments of the invention, the measurement of ROI1 signal 52 could be done by activating signals PWR1-PWR3 (see 56-58 in FIG. 4) of the power line addressing circuitry 66 and Row1-Row3 (see 60-64) of the row addressing circuitry 68. In this example, only a small number of row and column signals are shown for the purposes of clarity, however in a practical case, the number of columns and rows could be significantly higher. Additionally, it should be noted that any suitable number of columns and rows could be utilized.

According to various exemplary embodiments of the invention, the signals can be measured sequentially (first one color channel, then second color channel, and so forth) with, for example, a small time delay. According to some other exemplary embodiments of the invention, extra wiring may be incorporated in the pixel array to enable measuring simultaneously reset current from each color channel pixels independently. The color channel signals can be used, foe example, for defining the ambient light color temperature and adjusting display brightness and colors to suit ambient light conditions.

According to some embodiments of the invention, the image array may be divided to, for example, nine areas, wherein the light level signal from each one of these areas can be measured. This can be done either by color channel or all color channels combined. For example, according to one example of the invention nine light level signals may be provided. According to another example of the invention nine by four (9×4) color signals from whole array may be provided. This information may then be used for coarse event detection, such as, detecting a hand (or basically any object) that is swept over the phone 10 to mute it, or to detect movement in the field of view, for example. While the examples above have been described in connection with nine areas of the image array, one skilled in the art will appreciate that various exemplary embodiments of the invention are not necessarily so limited and that the image array may be divide into any suitable number of areas.

According to various exemplary embodiments of the invention provide for pixel power circuitry to be addressable, so that power line for each column of pixels can be switchable on/off. This for example, according to some embodiments of the invention, allows for the measuring of the color channels independently and for dividing the image array to smaller regions.

The arrangement 26 provides for the addition of ambient light sensing functionality to the camera 28 that allows for ambient light measurement, and for the measurement of the light level from different areas in the field of view of the camera 28, as well as a measurement of color temperature by measuring R, G and B (red, green, and blue) signals (as the camera sensor generally comprises RGB filters). Additionally, these measurements may be performed with substantially very low power.

Referring now also to FIG. 5, another exemplary embodiment of the invention is shown. In this embodiment, the arrangement 26 comprises relatively large photosensitive elements (photodiodes, “large pixels”) 70 that may located on the sides (or on top/bottom) of the pixel array 72 that is used for imaging. For example, with this configuration the pixel array 72 that is used for imaging could be left unpowered during ambient light sensor operation and current consumption could be greatly reduced. The larger than normal pixel size may be provided to improve sensitivity. The electrical signal that corresponds to the ambient light level is transformed to digital format inside the camera module and a single number that represents the light level is outputted from the camera module. The communication/powering interface could be the same that the camera uses for data communication and powering, or totally separated interface could be used. Similar to the embodiments above, the arrangement comprises circuitry that enables lower current consumption and lower data rate from the sensor. It should be noted that FIG. 5 presents one example orientation of the light sensing elements in the camera sensor, however in alternate embodiments, any suitable orientation may be provided.

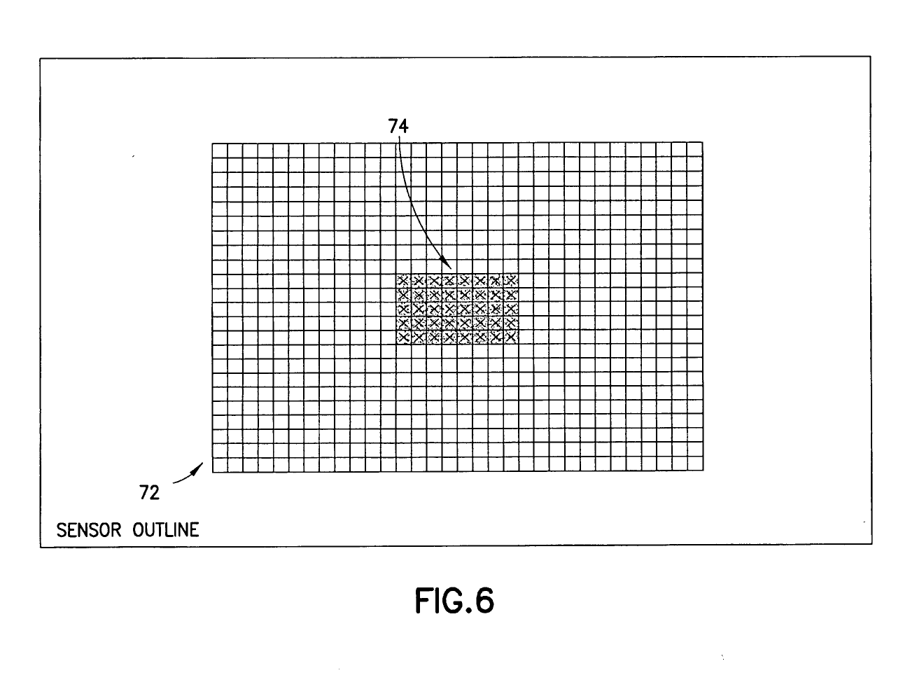

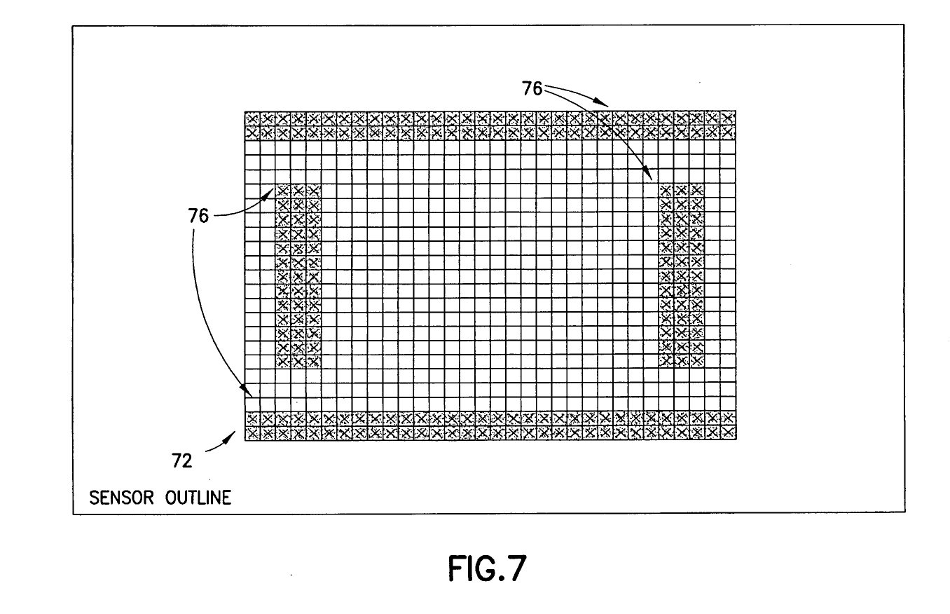

Referring now also to FIG. 6, another embodiment of the invention is shown wherein the arrangement 26 is configured to read out only a limited number of pixels from a middle area of the pixel array 72 (see area 74 illustrated with an “X” in each of the pixels). This embodiment, for example, has the advantage that due to standard optical lens properties the light intensity is highest in the middle of the pixel array 72. In this case the pixel data could be combined to one single numerical reading inside the camera electronics by combining all the pixels that are measured (for example by averaging or by applying more sophisticated processing). In some cases it could also be beneficial to output all pixel data and process it outside the camera. Powering and data communication could be provided as above (as in FIG. 5, for example). It should be noted that FIG. 6 presents the one example location of the light sensing area inside the pixel array, however in alternate embodiments, any suitable location(s) may be provided. For example, and referring now also to FIG. 7, the arrangement 26 may be configured to read out only a limited number of pixels from some arbitrary predetermined area of the pixel array 72 (see areas 76 illustrated with an “X” in each of the pixels), instead of the middle area 74. However, this is provided as a non-limiting example, and any other suitable locations of the light sensing area in the pixel array may be provided. Additionally, different areas could be read individually or in combination.

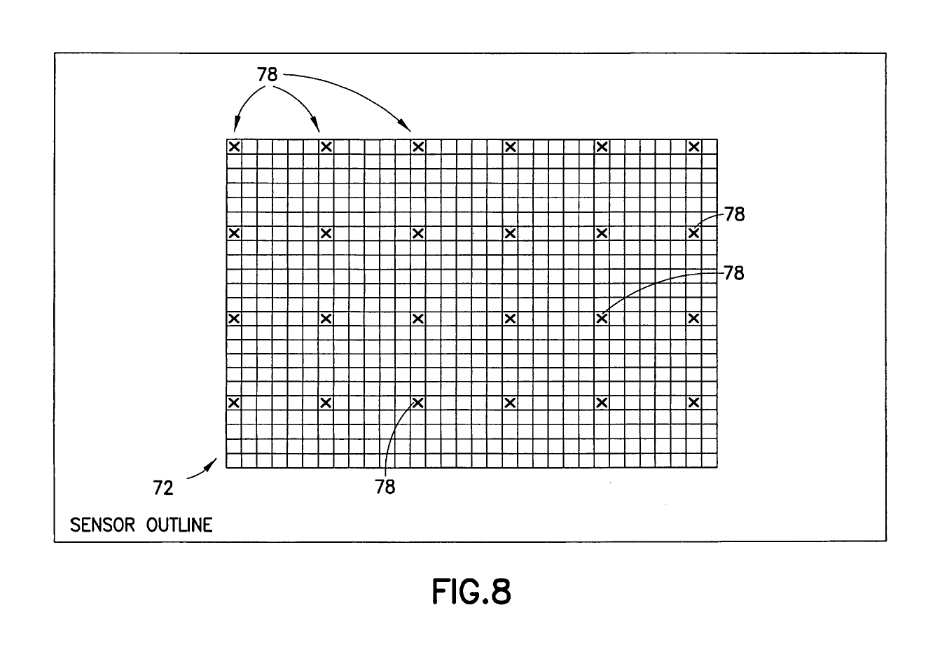

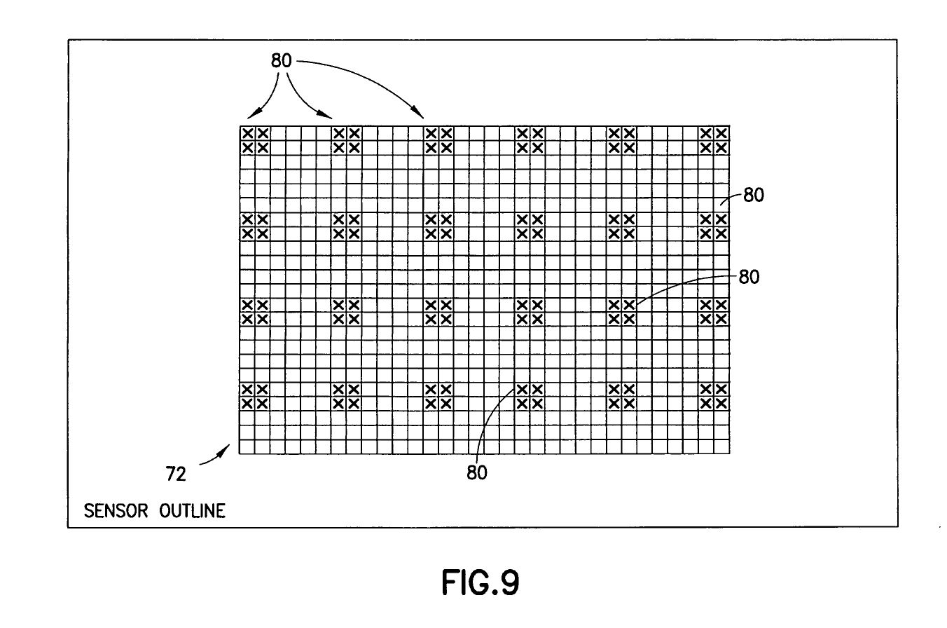

Referring now also to FIG. 8, another embodiment of the invention is shown wherein the arrangement 26 is configured to skip one or several pixels in both x and y direction when reading out (individual pixels of) the array 72 (see pixels 78 illustrated with an “X” in each of the pixels). For shared pixel structure, it is possible to read shared pixel groups and then skip one or more groups in both x and y directions (for example, see below and FIG. 9). This would enable smaller amount of data and power consumption and potentially ease the sensor design as standard sensor layout could be utilized. Additionally, output data communication could be provided as above (as in FIG. 5, for example).

Referring now also to FIG. 9, another embodiment of the invention is shown wherein the arrangement 26 is configured to provide one way of skipping pixel groups when reading pixel groups (see areas 80 illustrated with an “X” in each of the pixels). For example, the light sensitive portion may be similar to the embodiment in FIG. 5, but have an analog voltage outputted from the camera module. This could enable simple circuitry, easy design and potentially low power consumption as the ALS part of the camera could be totally isolated from the camera circuitry.

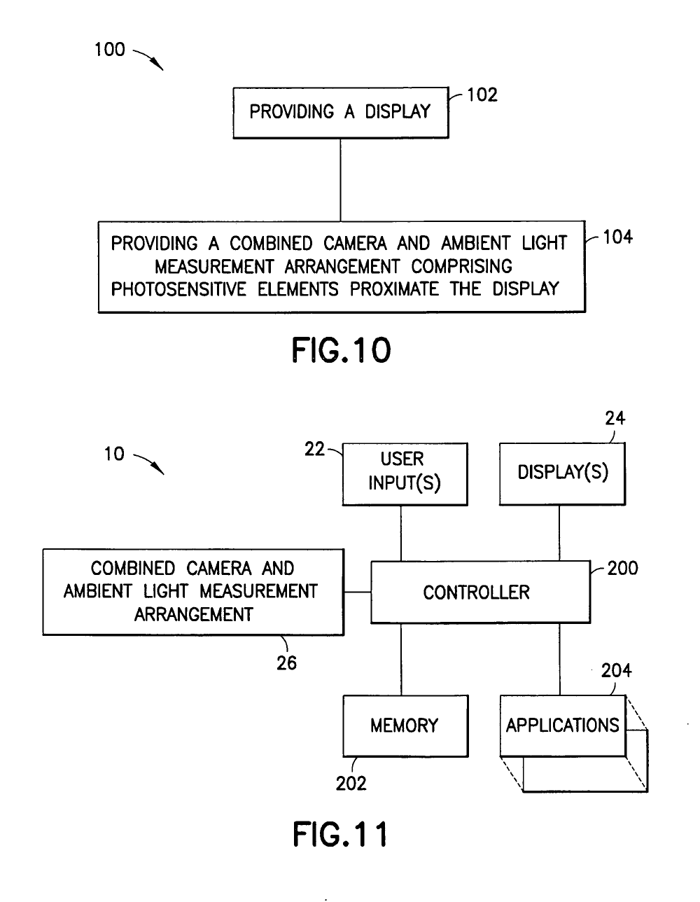

FIG. 10 illustrates a method 100. The method 100 includes providing a display (at block 102). Providing a combined camera and ambient light measurement arrangement 26 comprising photosensitive elements 34 proximate the display 24. The arrangement is configured to operate in a first power mode and a second different power mode. The arrangement 26 is configured to use the photosensitive elements to measure a color signal of light incident on the display when the arrangement is in the first power mode. The arrangement is configured to use the photosensitive elements to capture an image when the arrangement is in the second power mode (at block 104). It should be noted that the illustration of a particular order of the blocks does not necessarily imply that there is a required or preferred order for the blocks and the order and arrangement of the blocks may be varied. Furthermore it may be possible for some blocks to be omitted.

Referring now also to FIG. 11, the device 10 generally comprises a controller 200 such as a microprocessor for example. The electronic circuitry includes a memory 202 coupled to the controller 200, such as on a printed circuit board for example. The memory could include multiple memories including removable memory modules for example. The device has applications 204, such as software, which the user can use. The applications can include, for example, a telephone application, an Internet browsing application, a game playing application, a digital camera application, a map/gps application, and so forth. These are only some examples and should not be considered as limiting. One or more user inputs 22 are coupled to the controller 200 and one or more displays 24 are coupled to the controller 200. The combined camera and ambient light measurement arrangement 26 is also coupled to the controller 200. The device 10 may programmed for example, to automatically measure ambient light incident on the display 24.

Without in any way limiting the scope, interpretation, or application of the claims appearing below, a technical effect of one or more of the example embodiments disclosed herein is the combination of reading R, G, B channel signals, and multiple areas in the field of view of the camera with low power operation. For example, conventional configurations generally provide for reading only one signal representing ambient light level with low power (such as in the uW area, with a discrete ambient light sensor).

Another technical effect of one or more of the example embodiments disclosed herein is, in addition to one signal representing average light level, also color information and some spatial information can be obtained. Another technical effect of one or more of the example embodiments disclosed herein is providing the arrangement with only minor amount of extra circuitry in the image sensor, so cost is significantly lower than with traditional discrete ambient light sensor components. Another technical effect of one or more of the example embodiments disclosed herein is the integration of ambient light sensing to a camera, which reduces the size, cost, and simplifies the design (as no need for multiple “holes” on top of the phone cover for separate ambient light sensor). Another technical effect of one or more of the example embodiments disclosed herein is that the display color temperature can be adjusted according to surrounding light. Another technical effect of one or more of the example embodiments disclosed herein is proving for simple gesture recognition, as the light level can be measured from different multiple locations in the field of view (such as, waving the hand over the phone to silence it, for example).

Additional technical effects of any one or more of the exemplary embodiments provide an ambient light measurement system using a camera which provides improvements when compared to conventional configurations wherein a separate ambient light sensor is only measuring the average light level in one single photosensitive element. In these conventional configurations, the discrete ambient light sensor component adds system cost, and requires space in the phone and measures only one single signal that represents illuminance level. Additionally, having two different components, an ambient light sensor and a camera can result in extra cost and the external appearance of the phone can suffer from multiple “holes” in the front panel that are needed for various components.

It should further be noted that conventional electronic device camera usage generally comprises reading out several hundreds of thousands or even millions of pixels, which can consume a significant amount of power, and therefore an ambient light sensing function cannot generally be performed with a conventional camera readout circuit and image processing. For example, in an average situation the current consumption of the camera (such as a secondary, forward facing camera, for example) is approximately 100 times that of an ambient light sensor and amount of data is around 300,000 times larger (whole pixel array data of a VGA camera compared to output of one single number from ambient light sensor). In order to achieve the adequate accuracy and suitable format for the ambient light level information measured with secondary camera image in a conventional configuration, the image data would have to be processed which further consumes current and in some cases would require processing time from host processor. For example, a camera operating in a low resolution mode and low power mode generally comprises power consumption in the several mW area. Thus, the use of conventional cameras for ambient light sensing is generally not feasible, as the electrical current consumption and amount of data from the secondary camera is so large that it is not feasible to use existing cameras as such for the sole light level sensing purpose.

Technical effects of any one or more of the exemplary embodiments provide a method of measuring the ambient light in a camera. Wherein the method uses a signal to measure the light level and the color information is gathered from the sensor by combining one color channel pixel together and measuring the required current that flows through the array when light hits the pixel. The signals can be measured either sequentially (first one color channel then second, and so forth) with small time delay, or extra wiring has to be incorporated to pixel array to enable measuring simultaneously reset current from each color channel pixels independently. The color channel signals can be used, for example for defining the ambient light color temperature and adjusting display brightness and colors to suit ambient light conditions.

Another technical effect of one or more of the example embodiments disclosed herein is providing a signal to measure the light level, wherein color information is gathered collectively (columnwise/rowwise) from a group of pixels using other signal, with enhanced user experience and lower power consumption when measuring ambient light when compared to normal camera usage (such as during image capture).

While various exemplary embodiments of the invention have been described in connection with integrating ambient light sensing capability in the secondary (or forward facing) camera 28, one skilled in the art will appreciate that embodiments of the invention are not necessarily so limited and that some exemplary embodiments of the invention may be configured such that the combined camera and ambient light measurement arrangement 26 may additionally (or instead) use the primary (or rearward facing) camera 32. For example, some embodiments of the invention may utilize the primary camera, in a situation where the user of the device is holding the device in such position that the light source (sun, ceiling lights, for example) is pointing towards the user's eyes. In practice may not be very a comfortable situation for the user and usually lighting is arranged so that it comes from behind, and on a personal level, the user may not want to stare at the sun and hold the phone in the same direction, while trying to read the display. This may occur when the user is lying down on his/her back (such as at the beach where the sun could be bright in the viewing direction, or indoors proximate bright overhead lighting, for example) and surfing the internet on the device. In these situations, the arrangement 26 could utilize the primary camera 32 (or both the primary camera 32 and the secondary camera 28) to adjust the display backlight based on the light source. Additionally, the arrangement 26 could be configured to use the primary camera 32 and/or the secondary camera 28 for any other suitable type daylight cancellation or front light flash combination use cases.

It should be understood that components of the invention can be operationally coupled or connected and that any number or combination of intervening elements can exist (including no intervening elements). The connections can be direct or indirect and additionally there can merely be a functional relationship between components.

As used in this application, the term ‘circuitry’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Embodiments of the present invention may be implemented in software, hardware, application logic or a combination of software, hardware and application logic. The software, application logic and/or hardware may reside on the electronic device 10 (such as on the memory 202, or another memory of the device), on a server, or any other suitable location. If desired, part of the software, application logic and/or hardware may reside on the device, and part of the software, application logic and/or hardware may reside on the server. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 11. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Below are provided further descriptions of various non-limiting, exemplary embodiments. The below-described exemplary embodiments are separately numbered for clarity and identification. This numbering should not be construed as wholly separating the below descriptions since various aspects of one or more exemplary embodiments may be practiced in conjunction with one or more other aspects or exemplary embodiments. That is, the exemplary embodiments of the invention, such as those described immediately below, may be implemented, practiced or utilized in any combination (for example, any combination that is suitable, practicable and/or feasible) and are not limited only to those combinations described herein and/or included in the appended claims.

In one exemplary embodiment, an apparatus comprising: a display; and a combined camera and ambient light measurement arrangement comprising photosensitive elements. The arrangement is configured to operate in a first power mode and a second different power mode. The arrangement is configured to use the photosensitive elements to measure a color signal of light incident on the display when the arrangement is in the first power mode. The arrangement is configured to use the photosensitive elements to capture an image when the arrangement is in the second power mode.

An apparatus as above, wherein the arrangement is configured to adjust a brightness of the display in response to the measured color signal.

An apparatus as above, wherein the color signal corresponds with a portion of a field of view of the camera, and wherein the arrangement is configured to use the photosensitive elements to capture an image in the field of view of the camera.

An apparatus as above, wherein the photosensitive elements comprise photosensitive pixels.

An apparatus as above, wherein the arrangement is configured to use the photosensitive elements to measure an ambient light color temperature of the light incident on the display.

An apparatus as above, wherein the arrangement comprises circuitry, and wherein the circuitry is configured to be addressable.

An apparatus as above, wherein the arrangement is configured to use the photosensitive elements to obtain spatial information relative to the display.

An apparatus as above, wherein the arrangement is configured to operate with a first data rate when using the photosensitive elements to measure the color signal of light incident on the display, and wherein the arrangement is configured to operate with a second data rate when using the photosensitive elements to capture the image, and wherein the first data rate is substantially less that the second data rate.

An apparatus as above, wherein the arrangement is configured to use the photosensitive elements to measure a red, green, blue channel signal of light incident on the display when the arrangement is in the first power mode.

An apparatus as above, wherein the apparatus comprises a mobile phone.

In another exemplary embodiment, an apparatus comprising: a camera comprising photosensitive elements, at least one processor connected to the camera, and at least one memory including computer program code. The at least one memory and the computer program code configured to, with the at least one processor, cause the apparatus to perform at least the following: sense a first ambient light level with the photosensitive elements, wherein the first ambient light level corresponds with a portion of a field of view of the camera. Capture an image with the photosensitive elements in the field of view of the camera. Adjust a brightness of a display of the apparatus in response to the sensed first ambient light level.

An apparatus as above, wherein the at least one memory and the computer program code configured to, with the at least one processor, cause the apparatus to further perform at least the following: sense a second ambient light level with the photosensitive elements, wherein the second ambient light level corresponds with another different portion of a field of view of the camera. Adjust a brightness of a display of the apparatus in response to the sensed first and second ambient light levels.

An apparatus as above, further comprising a combined camera and ambient light measurement arrangement, wherein the arrangement comprises the photosensitive elements.

An apparatus as above, wherein the at least one memory and the computer program code are configured to, with the at least one processor, cause the apparatus to sense the first ambient light level with the photosensitive elements when at least a portion of the apparatus is in a first power mode, and configured to capture the image when at least a portion of the apparatus is in a second different power mode.

An apparatus as above, wherein the at least one memory and the computer program code are configured to, with the at least one processor, cause the apparatus to measure a color signal of light incident on the display.

An apparatus as above, wherein the at least one memory and the computer program code configured to, with the at least one processor, cause the apparatus to further perform at least the following: measure a color signal of light incident on a display of an apparatus, wherein the measuring is performed, at least partially, with photosensitive elements of the apparatus. Adjust an illumination brightness of the display based on the measured color signal of the light incident on the display of the apparatus.

In another exemplary embodiment, a computer program product comprising a computer-readable medium bearing computer program code embodied therein for use with a computer, the computer program code comprising: code for measuring a color signal of light incident on a display of an apparatus, wherein the measuring is performed, at least partially, with photosensitive elements of the apparatus. Code for capturing an image with the photosensitive elements. Code for adjusting an illumination brightness of the display based on the measured color signal of the light incident on the display of the apparatus.

A computer program product as above, wherein the code for measuring further comprises code for measuring the color signal of light incident on the display of an apparatus, wherein a combined camera and ambient light measurement arrangement of the apparatus is configured to use the photosensitive elements for measuring the color signal.

A computer program product as above, wherein the code for measuring the color signal is configured to be used when at least a portion of the apparatus is in a first power mode, and wherein the code for capturing the image is configured to be used when at least a portion of the apparatus is in a second different power mode.

A computer program product as above, further comprising: code for sensing a first ambient light level with the photosensitive elements, wherein the first ambient light level corresponds with a portion of a field of view of a camera of the apparatus. Code for capturing an image in the field of view of the camera. Code for adjusting a brightness of the display of in response to the sensed first ambient light level.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. An apparatus, comprising:
a display; and
a combined camera and ambient light measurement arrangement comprising photosensitive elements, wherein the arrangement is configured to operate in a first power mode and a second different power mode, wherein the arrangement is configured to use the photosensitive elements to measure a color signal of light incident on the display when the arrangement is in the first power mode, and wherein the arrangement is configured to use the photosensitive elements to capture an image when the arrangement is in the second power mode.

2. An apparatus as in claim 1 wherein the arrangement is configured to adjust a brightness of the display in response to the measured color signal.

3. An apparatus as in claim 1 wherein the color signal corresponds with a portion of a field of view of the camera, and wherein the arrangement is configured to use the photosensitive elements to capture an image in the field of view of the camera.

4. An apparatus as in claim 1 wherein the photosensitive elements comprise photosensitive pixels.

5. An apparatus as in claim 1 wherein the arrangement is configured to use the photosensitive elements to measure an ambient light color temperature of the light incident on the display.

6. An apparatus as in claim 1 wherein the arrangement comprises circuitry, and wherein the circuitry is configured to be addressable.

7. An apparatus as in claim 1 wherein the arrangement is configured to use the photosensitive elements to obtain spatial information relative to the display.

8. An apparatus as in claim 1 wherein the arrangement is configured to operate with a first data rate when using the photosensitive elements to measure the color signal of light incident on the display, and wherein the arrangement is configured to operate with a second data rate when using the photosensitive elements to capture the image, and wherein the first data rate is substantially less that the second data rate.

9. An apparatus as in claim 1 wherein the arrangement is configured to use the photosensitive elements to measure a red, green, blue channel signal of light incident on the display when the arrangement is in the first power mode.

10. An apparatus as in claim 1 wherein the apparatus comprises a mobile phone.

11. An apparatus, comprising:
a camera comprising photosensitive elements;
at least one processor connected to the camera; and
at least one memory including computer program code
the at least one memory and the computer program code configured to, with the at least one processor, cause the apparatus to perform at least the following:
sense a first ambient light level with the photosensitive elements, wherein the first ambient light level corresponds with a portion of a field of view of the camera;
capture an image with the photosensitive elements in the field of view of the camera; and
adjust a brightness of a display of the apparatus in response to the sensed first ambient light level.

12. An apparatus as in claim 11 wherein the at least one memory and the computer program code configured to, with the at least one processor, cause the apparatus to further perform at least the following:
sense a second ambient light level with the photosensitive elements, wherein the second ambient light level corresponds with another different portion of a field of view of the camera; and
adjust a brightness of a display of the apparatus in response to the sensed first and second ambient light levels.

13. An apparatus as in claim 11 further comprising a combined camera and ambient light measurement arrangement, wherein the arrangement comprises the photosensitive elements.

14. An apparatus as in claim 11 wherein the at least one memory and the computer program code are configured to, with the at least one processor, cause the apparatus to sense the first ambient light level with the photosensitive elements when at least a portion of the apparatus is in a first power mode, and configured to capture the image when at least a portion of the apparatus is in a second different power mode.

15. An apparatus as in claim 11 wherein the at least one memory and the computer program code are configured to, with the at least one processor, cause the apparatus to measure a color signal of light incident on the display.

16. An apparatus as in claim 11 wherein the at least one memory and the computer program code configured to, with the at least one processor, cause the apparatus to further perform at least the following:
measure a color signal of light incident on a display of an apparatus, wherein the measuring is performed, at least partially, with photosensitive elements of the apparatus; and
adjust an illumination brightness of the display based on the measured color signal of the light incident on the display of the apparatus.

17. A computer program product comprising a computer-readable medium bearing computer program code embodied therein for use with a computer, the computer program code comprising:
code for measuring a color signal of light incident on a display of an apparatus, wherein the measuring is performed, at least partially, with photosensitive elements of the apparatus;
code for capturing an image with the photosensitive elements; and
code for adjusting an illumination brightness of the display based on the measured color signal of the light incident on the display of the apparatus.

18. A computer program product as in claim 17 wherein the code for measuring further comprises code for measuring the color signal of light incident on the display of an apparatus, wherein a combined camera and ambient light measurement arrangement of the apparatus is configured to use the photosensitive elements for measuring the color signal.

19. A computer program product as in claim 17 wherein the code for measuring the color signal is configured to be used when at least a portion of the apparatus is in a first power mode, and wherein the code for capturing the image is configured to be used when at least a portion of the apparatus is in a second different power mode.

20. A computer program product as in claim 17 further comprising:
code for sensing a first ambient light level with the photosensitive elements, wherein the first ambient light level corresponds with a portion of a field of view of a camera of the apparatus;
code for capturing an image in the field of view of the camera; and
code for adjusting a brightness of the display of in response to the sensed first ambient light level.
